(19) United States
(12) Patent Application Publication
(10) Pub. No.: US 2026/0304520 A1
(43) Pub. Date: Oct. 1, 2026

(54) MOVING PDU SESSIONS BETWEEN NETWORKS

(71) Applicant: InterDigital Patent Holdings, Inc., Wilmington, DE (US)

(72) Inventors: Michael Starsinic, Newtown, PA (US); Saad Ahmed, Montreal (CA); Ulises Olvera-Hernandez, Saint-Lazare (CA); Anuj Sethi, Ottawa (CA); Mohamad Kenan AI-Hares, Canterbury (GB)

(73) Assignee: InterDigital Patent Holdings, Inc., Wilmington, DE (US)

(21) Appl. No.: 19/092,679

(22) Filed: Mar. 27, 2025

(51) Int. Cl. H04W 76/15; H04W 48/18; H04W 60/00; H04W 76/34

(52) U.S. Cl. CPC H04W 76/15; H04W 48/18; H04W 60/00; H04W 76/34

(57) ABSTRACT

Method are disclosed for a wireless transmit/receive unit (WTRU) to transition between a first wireless network, e.g., 6G network, and a second wireless network, e.g., 5G network, having different session management protocols. In one method, session management procedures are performed via non-access stratum (NAS) signaling that is carried in signalling radio bearers (SRBs) and then session management procedures are performed via application layer signaling that is carried in data radio bearers (DRBs) such that both types of session management procedures can relate to the same PDU session anchor (PSA) user plane function (UPF). The disclosed methods allow the WTRU to communicate via the same PSA UPF when moving between networks (e.g. moving between a 5G network and a 6G network) and consequently allow the WTRU to maintain the same IP address(es) when moving between the 5G network and 6G network. Various embodiments are disclosed.

### BACKGROUND

When a packet or protocol data unit (PDU) session is established and maintained in a 5G network, a mobile station, interchangeably referred to herein as a user equipment (UE) or wireless transmit/receive unit (WTRU), uses non-access stratum (NAS)-session management (SM) messaging to communicate with the service management function (SMF) that manages the session. Managing the session may include configuring quality of service (QoS) for the session, configuring QoS flows for the PDU session, and configuring the user plane function (UPF) for the session. In the 5G network, the NAS-SM messaging is sent via the control plane and signalling radio bearers (SRBs) are used to send the NAS-SM messages between the WTRU and radio access network (RAN) Node, e.g., base station or gNB.

In a 6G network, session management signaling may be carried in application signaling. Consequently, then interworking procedures between the 5G network and 6G network may need to be different than the procedures that are used to interwork between the 4G and 5G networks. Protocols and procedures for a WTRU to be able to use the same IP address(es) for some of its application layer traffic would be beneficial when the WTRU moves between the 5G network and 6G network regardless of the session management protocols used in both networks.

### SUMMARY

According to various aspects, methods are disclosed for a wireless transmit/receive unit (WTRU) to transition between a first wireless network, e.g., 6G network, and a second wireless network, e.g., 5G network, or vice versa, that use different session management protocols. In one aspect, session management procedures are performed via non-access stratum (NAS) signaling that is carried in signalling radio bearers (SRBs) and then session management procedures are performed via application layer signaling that is carried in data radio bearers (DRBs) such that both types of session management procedures can relate to the same PDU session anchor (PSA) user plane function (UPF). Accordingly, the disclosed methods may allow a WTRU to communicate via the same PSA UPF when moving between networks (e.g. moving between a 5G network and a 6G network) and consequently allow the WTRU to maintain the same IP address(es) when moving between the 5G network and 6G networks.

In one example aspect, a WTRU receives a Slice Specific NAS Ingress Identifier from a 6G network and initiates a PDU session establishment procedure with the 6G network to a establish a first PDU session by sending a PDU Session Establishment Request to the Slice Specific NAS Ingress that is associated with the Slice Specific NAS Ingress Identifier. In an example, a second PDU session may be used to send the PDU Session Establishment Request message that initiates the PDU session establishment procedure. In an example, the WTRU may be configured with a UE route selection policy rule (URSP) rule, also referred to as a route selection policy rule, that includes a traffic descriptor which may indicate NAS signaling. The URSP rule may be used by the WTRU to determine which PDU session (e.g., the second PDU session) should be used to send the PDU Session Establishment Request message that initiates the PDU session establishment procedure. The WTRU may receive a PDU Session Establishment Accept message and then register with a 5G network. The WTRU performs a PDU session establishment procedure with a 5G network to a establish a third PDU session. In an example, prior to performing the PDU session establishment procedure with the 5G network, the WTRU may receive a URSP rule. The URSP rule may include a traffic descriptor associated with interworking or NAS signaling and the WTRU uses the URSP rule to determine a DNN and S-NSSAI combination to indicate to the network during the PDU session establishment procedure of the third PDU session. The WTRU may use the third PDU session to send a PDU Session Modification Request to the Slice Specific NAS Ingress and to send a message to the Slice Specific NAS Ingress and uses the third PDU session to receive a PDU Session Modification Command from a network function (NF) of the 6G network.

In another example aspect, a WTRU moves from a legacy network, e.g., 5G, to a next generation mobile network, e.g., 6G. The WTRU receives URSP Rules and a list of slices that the WTRU is permitted to access via the 5G network, as well as information indicating which slices are accessible via the 6G network and that support NAS signaling via the application layer (AL). The WTRU receives a first PDU from an application for transmission, and uses a first URSP rule evaluation procedure to determine a first single network slice selection assistance information (S-NSSA)/data network name (DNN) combination that should be used to transmit the PDU. The WTRU detects that the S-NSSAI/DNN combination is accessible via the 5G network and 6G network. The WTRU determines to establish a PDU Session so that it can send data via the S-NSSAI/DNN combination. Because the DNN/S-NSSAI is accessible via NAS signaling, the WTRU will attempt the send the NAS-SM PDU Session Establishment Request message via application layer signaling, which will trigger a second URSP rule evaluation procedure. The result of the second URSP rule evaluation procedure is that a second DNN/S-NSSAI combination is determined.

The WTRU will perform a first PDU session establishment procedure and indicate the second DNN/S-NSSAI combination to the network in the first PDU session establishment procedure. The PDU Session Establishment Request message will be sent to the network via a signal radio bearer (SRB), which results in a first PDU session being established, which is used to send and receive NAS signaling via the application layer. The WTRU will perform a second PDU session establishment procedure and indicate the first DNN/S-NSSAI combination to the network in the second PDU session establishment procedure, where the PDU Session Establishment Request message will be sent to the network via an the first PDU session over data radio bearers (DRBs). The first PDU session may be used to send and receive application layer data (i.e. User Data), for example, media streaming. Additional advantages, features and aspects may be observed from the detailed embodiments which follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a functional network block diagram illustrating a method for a WTRU moving from a 6G network to a 5G network according to one example embodiment;

FIG. 3 is a functional network block diagram illustrating a method for a WTRU moving from a 5G network to a 6G network according to one example embodiment;

FIG. 4 is a flow diagram illustrating a method for sending application layer non-access stratum (NAS) signaling to the 6G network via the 5G network;

FIG. 5 is a flow chart illustrating a method implemented by a WTRU in moving from a 6G network to a 5G network according to one example embodiment; and

FIG. 6 is a flow chart illustrating a method implemented by a WTRU in moving from a 6G network to a 5G network according to one example embodiment.

### DETAILED DESCRIPTION

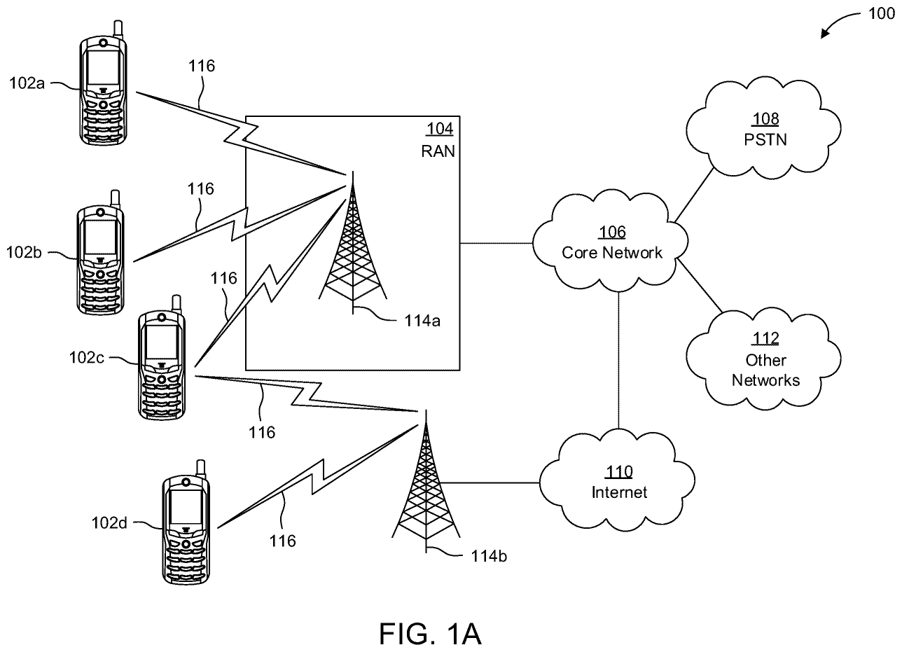

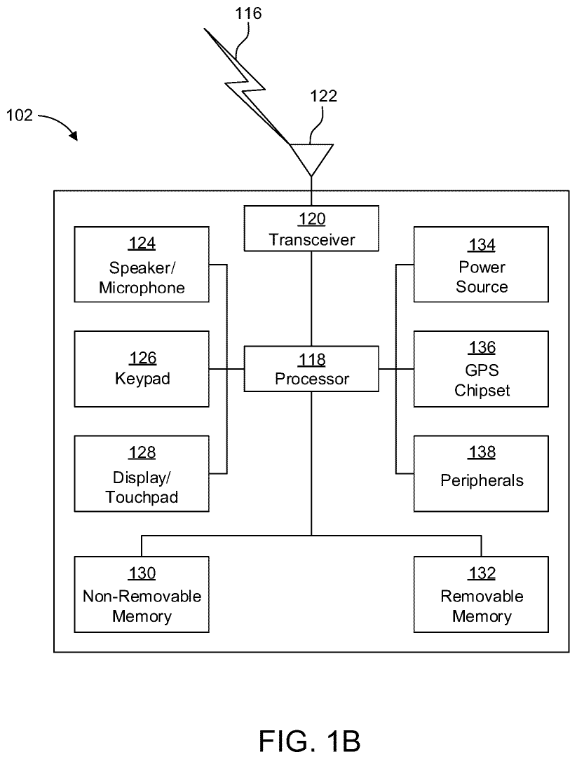

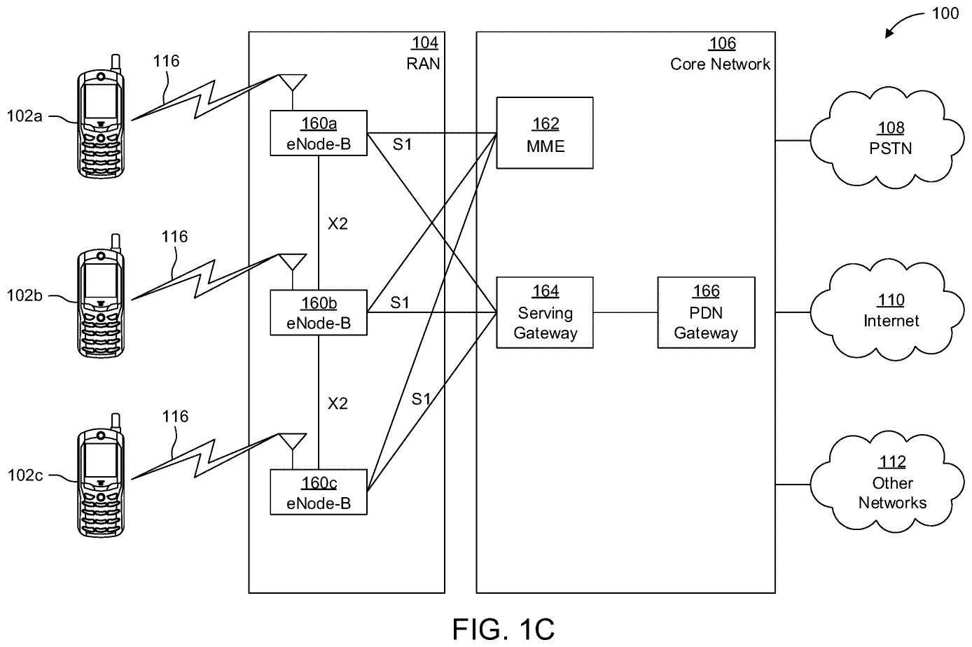

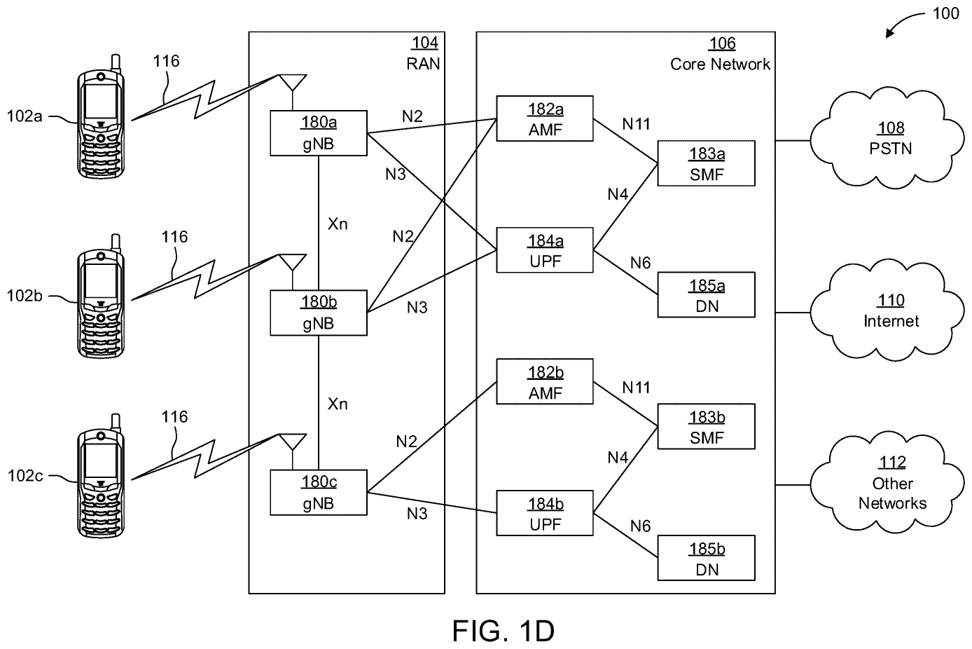

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In the example embodiments, the following terms are used as described. A network slice type describes a type of network slice. Since the network slice provides services, a network slice type may instead be called a network service type. NAS messages are a type of control plane message. NAS messages, or control plane messages, may be sent between the WTRU and network in a registration procedure. Registration procedures may not be slice specific. NAS messages, or control plane messages, may be sent between the WTRU and the network session management (SMF) procedures. Session management procedures may be slice specific. Examples of a RAN Node include a base station, gNodeB, an NR-RAN Node, and a 6G RAN Node. Interworking refers procedures that are used so that the WTRU can change its connection from a first network to a second network and interworking can refer procedures that are used so that the WTRU can simultaneously connect to a first network and to a second network. The 4G network, 5G network, and 6G network are examples of networks, and the embodiments are not limited by their specific reference in the example embodiments. The core network (CN) part of the 4G network is called an evolved packet core (EPC). The core network part of the 5G network is called a 5G core network (5GC). The core network part of the 6G network may be called 6GC.

In the 5G network and 4G network, all NAS signaling is sent over the control plane. In the 5G network and 4G network, all non-access stratum (NAS) signaling is sent between the WTRU and network via signalling radio bearers (SRBs). In the 5G network and 4G network, all session management (SM) signaling is sent between the WTRU and network via NAS signaling. In the 5G network, the WTRU uses a protocol data unit (PDU) session to send and receive PDUs. A PDU session may be established and modified via NAS signaling. In the 4G network, the WTRU uses a PDN Connection to send and receive PDUs. A PDN Connection may be established and modified via NAS signaling.

When the WTRU has a PDN connection established in the 4G network and connects to the 5G network, the WTRU may move its PDN connection to a PDU session in the 5G network by sending a PDU Session Establishment Request to the 5G network. When the WTRU sends the PDU Session Establishment Request, the WTRU may indicate a Request Type. If the Request Type indicates “Existing PDU Session” the access and mobility management function (AMF) selects the session management function (SMF) based on SMF-ID or SMF+PDN gateway-control plane (PGW-C) fully qualified domain name (FQDN) received from unified data management (UDM) during the Registration or Subscription Profile Update Notification procedure. The case where the AMF does not recognize the PDU Session ID or the subscription context that the AMF received from UDM neither contains an SMF ID nor a SMF+PGW-C FQDN corresponding to the PDU Session ID constitutes as an error case. If, in the 6G network, session management signaling is carried in application signaling, then interworking procedures between the 5G network and 6G network may need to be different than the procedures that are used to interwork between the 4G and 5G networks.

In various embodiments, a WTRU may be capable of connecting to 5G networks and 6G networks. Some WTRUs may be designed to operate in a mode where the WTRU only connects to one type of network at a time. For example, the WTRU may operate in a mode where it does not simultaneously connect to both the 5G network and the 6G network.

The WTRU may establish PDU sessions when the WTRU is connected to a 5G network. The WTRU may also establish a connection, or session, that is used for sending and receive PDUs when the WTRU is connected to a 6G network. Regardless of whether the WTRU is connected to a 5G network or a 6G network, the WTRU will send and receive PDUs to and from a data network. The path between the WTRU and data network will include a RAN Node and a PDU session anchor (PSA) user plane function (UPF). When the PDUs are IP packets, the PSA UPF will be the anchor for the WTRU's IP address.

When the WTRU disconnects from a 5G network and connects to a 6G network or disconnects from 6G network and connect to a 5G network, it may be desirable for the WTRU's IP address(es) to remain constant (i.e. not change). Allowing the WTRU's IP address(es) to stay the same when switching between networks will simplify the design of some of the applications that run in the WTRU because the applications would not need to be designed to handle changing the IP address when moving between networks.

The WTRU may determine to change its connection from a 5G network to a 6G network (or vice versa) based on availability, and/or preference/subscription, of a 5G network or 6G network. The WTRU may determine to change its connection from a 5G network to a 6G network (or vice versa) based on availability of the certain services in one network.

When a PDU session is established and maintained in a 5G network, the WTRU uses non-access stratum (NAS)-session management (SM) messaging to communicate with the SMF that manages the session. In an example, managing the session includes configuring QoS for the session, configuring QoS flows for the PDU session, and configuring the UPF for the session. In the 5G network, the NAS-SM messaging is sent via the control plane and SRBs are used to send the NAS-SM messages between the WTRU and the RAN node(s).

When a connection or session is established in the 6G network for sending and receiving PDUs, the WTRU uses may use session management signaling to communicate with a network function (NF) that manages the connection or session that is used to carry PDUs. In examples, managing the session or connection includes configuring QoS for the session, configuring QoS flows for the PDU session, and/or configuring the user plane function (UPF) for the session. In the 6G network, the protocol for sending the session management signalling may be different than the NAS-SM protocol that is used in the 5G network. In the 6G network, the protocols that are used to send the session management signalling may be different than the NAS-SM protocol that is used in the 5G network. For example, in the 6G network, the session management signaling may be sent via the user plane. For example, session management signaling may be carried in protocols such as hyper text transfer protocol (HTTP), which runs on top of the IP protocol.

Protocols and procedures are needed so that the WTRU can use the same IP address(s) for some of its application layer traffic when the WTRU moves between the 5G network and 6G network, regardless of the session management protocols used in both networks.

Embodiments disclosed herein relate to performing session management procedures via NAS signaling that is carried in signalling radio bearers (SRBs) and then perform session management procedures via application layer signaling that is carried in data radio bearers (DRBs) such that both types of session management procedures can relate to the same PDU session anchor (PSA) user plane function (UPF). In other words, the WTRU's PSA UPF can be the same regardless of what type of session management procedure is used. This approach allows the WTRU to communicate via the same PSA UPF when moving between networks (e.g. moving between a 5G network and a 6G network). The disclosed embodiments allow the WTRU to maintain the same IP address(es) when moving between the 5G network and 6G network. The ability to maintain the WTRU's IP address(es) when moving between networks simplify WTRU application layer design and avoid application layer signaling otherwise are required when the WTRU's IP address changes.

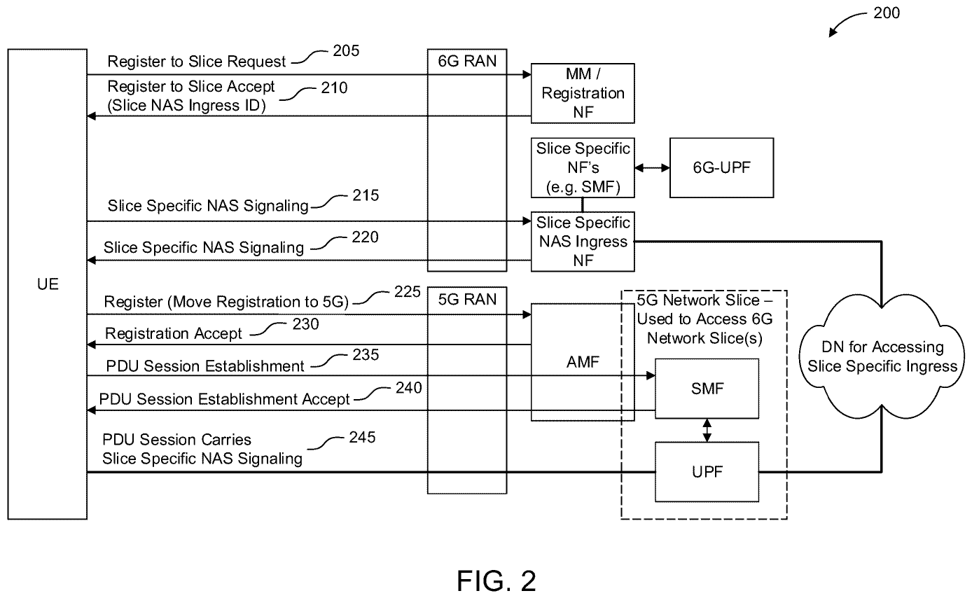

Referring to FIG. 2, a method 400 is shown for a WTRU moving from a next generation network, e.g., 6G, to a legacy wireless network, according to an example embodiment. Entities shown for the 6G network may include a 6G RAN node, mobility management (MM)/ registration network function (NF), slice specific NF's (e.g., SMF) and 6G UPF. Entities shown for the 5G network may include a 5G RAN node, e.g., gNB, an AMF, a SMF and a UPF, which as shown by the dashed line box, are 5G network slice elements used to access the 6G network slice(s) via a data network(s) for accessing slice-specific ingress of the 6G network.

FIG. 2, method 200 shows a WTRU: (i). establishes a connection, or session, that is used to send/receive PDUs via the 6G network; (ii) establishes a connection with a 5G network; and (iii) establishes a PDU session with the 5G network. In method 200 the WTRU may use the same PSA UPF for sending and receiving PDUs when the WTRU is connected to the 5G network and 6G network. Thus, the WTRU's IP address may be the same when it is connected to the 6G network and when the WTRU is connected the 5G network.

In this example, initially, the WTRU performs 6G registration in steps 205 and 210. The WTRU sends 205 a registration request to the 6G network. As an example, the registration request indicates at least one type of network slice that the WTRU wants to access, where each network slice type is identified by an single network slice selection assistance information (S-NSSAI).

Next, the WTRU receives 210 a registration response from the 6G network. In this example, the registration response indicates the types of network slices that the WTRU is permitted to access where each network slice type is identified by a S-NSSAI. For each network slice type that the WTRU is allowed to access, the 6G network may send the WTRU a Slice Specific NAS Ingress Identifier. The Slice Specific NAS Ingress Identifier may correspond to a Slice Specific data network access identifier (DNAI) associated with the UPF where the NF corresponding to this Network Slice Type may be reached.

A Slice Specific NAS Ingress Identifier is a network function that is part of a slice and that receives slice specific NAS messages and routes the slice specific NAS messages to other network functions of the slice. A Slice Specific NAS Ingress Identifier identifies where NAS messages that are specific to the network slice should be sent. For example, in order to establish a PDU session within a network slice, the WTRU may send a NAS message such as a PDU Session Establishment Request message to a network function in the slice. The Slice Specific NAS Ingress Identifier identifies a Slice Specific NAS Ingress node that can receive the PDU Session Establishment Request and either processes the PDU Session Establishment Request message or forwards it to another NF in the network slice that can process the message (e.g. the SMF)). When the Slice Specific NAS Ingress Identifier corresponds to a Slice Specific DNAI, the DNAI represents the potential location of NFs. The Slice Specific DNAI may also be sent in the policy and charging control (PCC) rule, to the SMF identified by the Slice Type, and to the WTRU as part of the UE route selection policy (URSP) rules.

In some examples, the message of step 210 may also include a pointer to the WTRU's context information. In an example, the format of the pointer may be a 5G S-Temporary Mobile Subscriber Identity (5G-S-TMSI). The pointer may be provided to a 5G network in a future procedure so that the 5G network can retrieve the WTRU's context information when the WTRU moves between 6G to 5G networks.

In various embodiments, the registration procedure that takes place between the WTRU and 6G network in steps 305 and 310 may be a control plane procedure. The messages of steps 205 and 210 may be NAS messages which are control plane messages that are sent via radio bearers that are designed for carrying control plane messages. Signaling radio bearers (SRBs) are examples of radio bearers that are designed for carrying control plane messages.

In method 200, a control plane procedure in a network slice (e.g. PDU session establishment) may be performed in steps 215 and 220. In step 215, the WTRU may send a message to a network slice. While the WTRU may not know the identity of the network slice, the WTRU received information during the registration procedure at step 210 that indicated what Slice Specific NAS Ingress Identifier, can be used to communicate with a type of network slice. The message of step 215 may include the Slice Specific NAS Ingress Identifier and a PDU Session Establishment Request. The network may forward the PDU Session Establishment Request to the Slice Specific NAS Ingress. The network knows what Slice Specific NAS Ingress node to send the PDU Session Establishment Request to because the Slice Specific NAS Ingress Identifier was in the message that was sent by the WTRU in step 215.

In certain embodiments, the PDU Session Establishment Request of step 215 may include an indication that the WTRU is 5G capable and possibly an indication of the 5G capabilities are enabled in the WTRU. This indication may be used by a network function in the slice (e.g. an SMF) during a UPF selection procedure. For example, the indication can be used to indicate that the network function in the slice should select a PSA UPF that can be reached by the 5G network.

In step 220, the WTRU may receive a response message from the network slice. In an example, the response message may be a PDU Session Establishment Accept message. In some implantations, the Slice Specific NAS Ingress may forward the PDU Session Accept message to the WTRU from another NF, such as a SMF.

The procedure that takes place between WTRU and network in steps 215 and 220 is a slice specific control plane procedure. In an example, the messages of steps 215 and 220 may be NAS messages which are control plane messages that are sent via radio bearers designed for carrying control plane messages. SRBs are examples of radio bearers that are designed for carrying control plane messages.

The messages of steps 215 and 220 may be carried in a PDU session. For example, after registration step 210, and before step 215, the WTRU may have established a PDU session with the network, which is not shown in FIG. 2 method 200. This PDU session may have been established for sending NAS messages to and from network slices. The PDU session may be a type of control plane default PDU session. If the PDU session uses Internet Protocol (IP), then the protocol that is used to carry the messages of the steps 215 and 220 may be an IP based protocol such as HTTP. If the PDU session is of type IP, then the Slice Specific NAS Ingress Identifier may be an IP Address or an identifier that can be resolved to an IP Address such as a fully qualified domain name (FQDN). If the PDU session is a non-IP type, then the Slice Specific NAS Ingress Identifier may be a value that is used by a data network to route the message to the Slice Specific NAS Ingress. If the messages of steps 215 and 220 are carried in a legacy PDU session, then the messages of steps 215 and 220 may be sent via data radio bearers (i.e. DRBs), which are the same type of radio bearers that are used to send data to and from WTRUs.

If the messages of steps 215 and 215 are carried in a PDU session, then a URSP Rule may be used to determine what PDU session to use to send the messages. In other words, a URSP Rule may be used to determine a data network name (DNN) and S-NSSAI combination that can be used to communicate with the Slice Specific NAS Ingress. For example, the traffic descriptor of the URSP Rule may indicate that the URSP Rule applies to all NAS signalling or NAS singling that is associated with a certain type of slice (i.e. S-NSSAI). Any combination of the foregoing examples may be used, e.g., messages in steps 205 and 210 may be exchanged in one type of radio bearer or protocol and messages in steps 215 and 300 may be exchanged is a different type of radio bearer or protocol.

Upon completion of step 220, the WTRU may be registered to the 6G network and have a PDU session established in a network slice via the 6G network. Upon completion of step 220, connection, or path, will have been established between the WTRU, 6G RAN, and a 6G-UPF. The WTRU will use this connection, or path, to send a receive data in the PDU session.

Although it is not shown in FIG. 2, both the 5G RAN and 6G RAN can connect to the 6G-UPF. Thus, when the WTRU moves between the 5G network and 6G network, the PSA UPF does not need to change and therefore the WTRU's IP address does not need to change. 5G registration in method 200 is shown and described in reference to steps 225 and 230. In step 225, the WTRU may determine to send a registration request to a 5G network. For example, the WTRU may have moved to a location where the 6G network is not available. In this step, the WTRU may send 225 a registration request to the 5G network. In an example, the registration request of step 225 may indicate that the registration request is a registration update. In an example, the registration request may include the 5G-S-TMSI that was received in step 210 via the 6G network. The AMF, which receives the registration request in the 5G network, may use the 5G-S-TMSI to identify a NF in the 6G network and request that the NF in the 6G network send the WTRU's context information to the AMF. In various examples, the message of step 225 may also include an indication that interworking with 6G is desired or a request to register with an S-NSSAI that is associated with interworking with 6G,

In step 230. the AMF may send a registration accept message to the WTRU. The registration accept message may indicate that the WTRU is registered to at least two types of network slices. First, the registration accept message may include an S-NSSAI that was sent to the WTRU in step 210, which may be the same S-NSSAI that is associated with the PDU session that was established in steps 215 and 220. Second, the registration accept message may include an S-NSSAI that is associated with interworking with 6G.

The S-NSSAI that is associated with interworking with 6G may be included in step 230 based on the indication that interworking with 6G is desired or the request to register with an S-NSSAI that is associated with interworking with 6G that was included in step 225.

Upon completion of step 230, connection, or path, will have been established between the WTRU, 5G RAN, and a 6G-UPF. The WTRU will use this connection, or path, to send and receive data in the PDU session to be established in steps 235 and 240. The AMF will use information from the WTRU's context to establish a tunnel between the 5G and 6G-UPF.

Establishing a PDU session in the 5G network that can be used to send control plane messages to the 6G network is next performed in steps 235 and 240. The PDU session will be associated with the S-NSSAI that is associated with interworking with 6G and/or NAS signaling. In other words, the S-NSSAI that is associated with interworking with 6G will be included in the PDU Session Establishment request at step 235.

A URSP Rule may be configured in the WTRU. A traffic descriptor (TD) in the URSP Rule may indicate interworking or NAS signaling. For example, the TD may be an application descriptor that indicates an association with interworking or NAS signaling. In an example, the TD may be a Connectivity Group ID that indicates an association with interworking or NAS signaling. In another example, the TD may be a connection capability value that indicates an association with interworking or NAS singling. The route selection descriptors (RSD(s)) of the UE route selection policy (URSP) Rule may describe a PDU session that can be used to send and receive to a Slice Specific NAS Ingress in the 6G network. In other words, the RSDs of the URSP Rule may include S-NSSAI and DNN combination(s) that can be used to send and receive to a Slice Specific NAS Ingress in the 6G network. Thus, when the WTRU needs to send traffic that is associated with interworking, the URSP Rule evaluation procedure may cause the WTRU to send traffic to a PDU session that is associated with a DNN and S-NSSAI combination that can be used to send and receive to a Slice Specific NAS Ingress in the 6G network. A purpose of the PDU session establishment procedure of step 235 and 240 is to establish a PDU session in the 5G network that can be used to send and receive to a Slice Specific NAS Ingress in the 6G network.

Upon completion of steps 235 and 240, the WTRU may be registered to the 5G network, have a PDU session established in a network slice of the 6G network, and a PDU session established in a network slice of the 5G network. The PDU session that is established in the network slice of the 5G network may be used to communicate with network functions on the 6G network.

At step 245, the WTRU may send and receive control plane messages with the 6G network slice. In step 245, the WTRU may send a PDU Session Modification Request to the network slice of the 6G network. The messages of step 245 may be NAS messages and carried in the PDU session that was established in steps 235 and 240. If the PDU session is of an IP type, then the protocol that is used to carry the messages of step 245 may be an IP based protocol such as HTTP. Further, if the PDU session is of type IP, then the Slice Specific NAS Ingress Identifier may be an IP address or an identifier that can be resolved to an IP Address such as an FQDN. If the PDU session is of a non-IP type, then the Slice Specific NAS Ingress Identifier may be a value that is used by a data network to route the message to the Slice Specific NAS Ingress. Since the messages of step 245 are carried in a PDU session, then the messages of step 245 may be sent via data radio bearers (i.e. DRBs), which are the same type of radio bearers that are used to send data to and from WTRUs.

In one example, the first message that is sent in step 245 may be a message to establish application layer contact with the Slice Specific NAS Ingress function. A purpose of the message may be to provide the Slice Specific NAS Ingress with the address of the WTRU. For example, if the PDU session is of an IP type, then the message can be used to provide the WTRU's IP address to the Slice Specific NAS Ingress. In other words, the IP address may be used by the Slice Specific NAS Ingress to contact the WTRU. For example, the Slice Specific NAS Ingress may use the WTRU's IP address to route a PDU Session Modification Command to the WTRU. The messages of step 245 sent via DRBs are sent via the data plane (i.e. QoS Flows) of the PDU session that was established in steps 235 and 240.

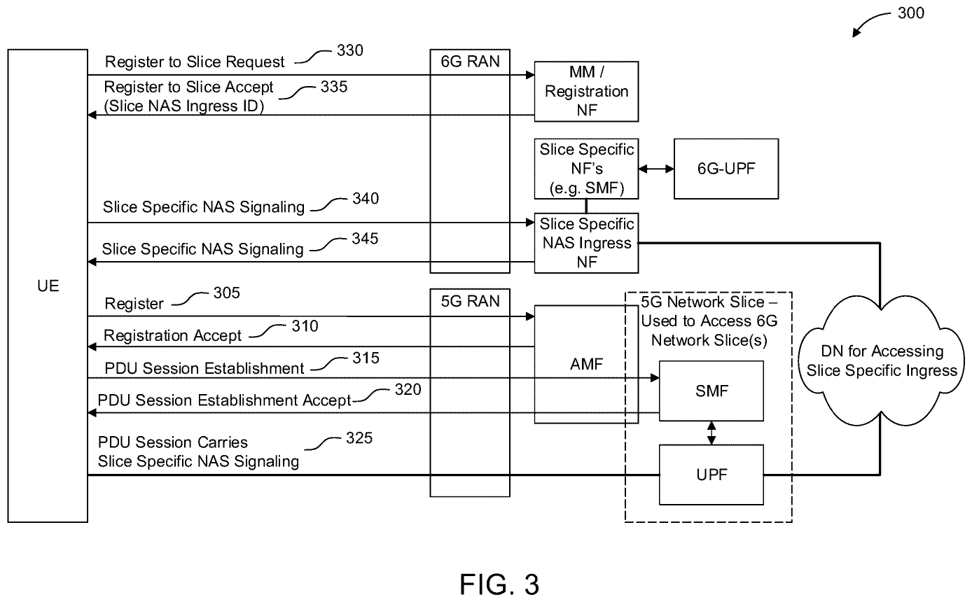

An embodiment of a WTRU moving from 5G to 6G is shown an described in reference to FIG. 3, which shows an example method 300 for how a WTRU may: (i) establish a PDU session with the 5G network; (ii) establish a connection with a 6G network; and (iii) establish a connection, or session, that is used to send PDUs via the 6G network.

In the example method 300, the WTRU may use the same PSA UPF for sending and receiving PDUs when the WTRU is connected to the 5G network and 6G network. Thus, the WTRU's IP address may be the same when it is connected to the 6G network as when the WTRU is connected the 5G network.

Note that the illustrations of FIG. 2 and FIG. 3 are similar, including the same network entities. However, interaction with the 5G network and 6G network are performed in a different order and the content of the messages that are sent to the 5G network and 6G network may be different when comparing methods of FIG. 2 and FIG. 3.

As described previously, 6G Slice Specific NAS signaling may be control plane signaling that is carried in the application layer. In other words, 6G Slice Specific NAS signaling may be control plane signaling that is carried in a PDU session. In method 300, a 5G WTRU is enhanced so that the WTRU may send 5G Slice Specific NAS signaling in a PDU session. One advantage of this approach is that the session management signaling of the WTRU may be sent using the same NAS application layer protocol regardless of whether the WTRU is connected to the network via a 5G or 6G base station.

In method 300, WTRU registration with the 5G network may be performed in registration request step 305 and registration accept step 310. As part of the registration procedure, or subsequent to the registration procedure (e.g. in a WTRU Configuration Update Procedure), the WTRU may receive URSP Rules from the network.

As part of the registration procedure, or subsequent to the registration procedure (e.g. in a WTRU Configuration Update Procedure), the WTRU may receive an indication that the 5G network supports NAS application layer signaling. The indication may be a per-slice indication. For example, the WTRU may receive an indication that interworking is not supported for some types of network slices (i.e. each type of slice may be identified by an S-NSSAI) and the WTRU may receive an indication that interworking is supported for some other types of network slices (i.e. each type of slice may be identified by an S-NSSAI).

The WTRU may next establish a PDU session in the 5G network that can be used to send control plane messages to the 6G network in step 315 PDU Session Establishment Request and step 320 PDU Session Establishment Accept messages.

After step 310, a WTRU application may attempt to send a PDU through the network. This may trigger the WTRU to perform a first URSP Rule evaluation. This URSP Rule evaluation procedure will be used to determine a DNN/S-NSSAI combination that can be used to send the PDU from the WTRU application. The WTRU may detect that it has no PDU session established that is associated with the data network name (DNN)/single network slice selection assistance information (S-NSSAI)/data network access identifier (DNAI) combination. Therefore, the WTRU will determine to send 315 a non-access stratum (NAS)-session management (SM) protocol data unit (PDU) Session Establishment Request message to establish a PDU session that is associated with the DNN/S-NSSAI/DNAI combination. The WTRU may, use the information that was received at step 310 in the prior registration procedure to determine that the DNN/S-NSSAI/DNAI is accessible via the 5G network and the 6G network. Since the DNN/S-NSSAI/DNAI is accessible via the 5G network and the 6G network, the WTRU may determine to send the NAS-SM message via application layer signaling.

The attempt to send the NAS-SM message via application layer signaling may trigger another URSP Rule evaluation procedure. The second URSP Rule evaluation procedure will be used to determine a second DNN/S-NSSAI combination, which can be used to establish a PDU session to send the NAS application layer signaling. Alternatively, instead of determining the DNN/S-NSSAI/DNAI combination in a URSP Rule evaluation procedure, the WTRU may receive the DNN/S-NSSAI/DNAI combination that should be used for interworking from the 5G network during a registration procedure. For example, the 5G network may send, to the WTRU, the DNN/S-NSSAI/DNAI combination and an indication that the combination should be used for application layer NAS signaling.

In steps 315 and 320, the WTRU performs a PDU session establishment procedure with the 5G network. The NAS-SM PDU Session Establishment Request of step 315 and PDU Session Establishment Accept message of step 320 will be sent via the 5G control plane. In other words, the messages will be sent via SRBs to an SMF in the 5G network.

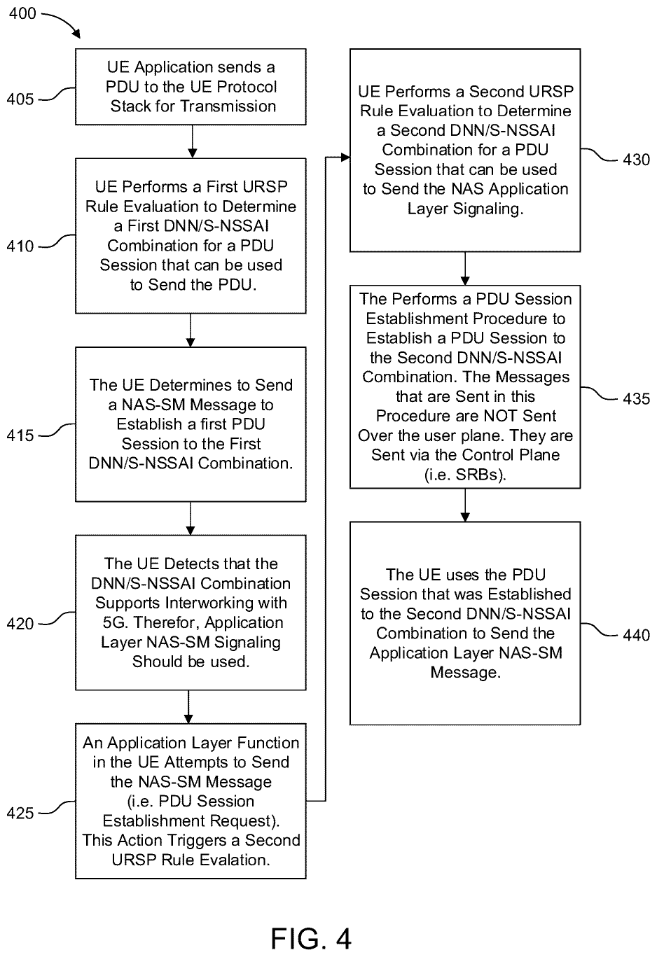

In step 325, the WTRU will use the PDU session that was established in steps 315 and 320 to send application layer NAS-SM signaling to the 6G network. This signaling will be used to perform a PDU session establishment procedure with the 6G network. The PDU session that is established with the 6G network can then be used to send and receive data via both the 5G network and the 6G network. Example details of the steps that are described as taking place after step 310 and though step 325 are further illustrated in FIG. 4 method 400.

Returning to FIG. 3, method 300, in steps 330 and 335, the WTRU may perform a registration procedure with the 6G network. The PDU session that was established in steps 315 and 320 may be released and the PDU session with Slice Specific NAS signaling established in step 325 may be maintained. In steps 340 and 345, the WTRU may perform a PDU session modification procedure to modify the PDU session that was established in step 325. These steps may be as described in steps 215 and 220 of FIG. 2.

Referring to FIG. 4, a method 400 for sending application layer NAS signaling to the 6G network via the 5G network is shown according to one example embodiment. Again, method 400 is an example of the steps that are described as taking place after step 310 and though step 325 of FIG. 3. In step 405, a WTRU application sends a PDU to the WTRU protocol stack for transmission. Next, at step 410, the WTRU performs a first URSP Rule evaluation to determine a first DNN/S-NSSAI combination for a PDU session that can be used to send the PDU. The WTRU determines 415 to send a NAS-SM message to establish a first PDU session to the first DNN/S-NSSAI combination and detects 420 the first DNN/S-NSSAI combination supports interworking with 5G so application layer NAS-SM signaling should be used.

At step 425, an application layer function in the WTRU attempts to send the NAS-SM message (i.e., a PDU Session Establishment Request for the 6G network), which triggers a second URSP Rule evaluation. The WTRU performs 430 the second URSP Rule evaluation to determine a second DNN/S-NSSAI combination that may be used to send the NAS application layer signaling. At step 435, a PDU session establishment procedure is performed by exchanging messages over the control plane (i.e., using SRBs) to establish a PDU session to the second DNN/S-NSSAI combination. Lastly, the control plane-based PDU session is then used to send 440 the application layer NAS-SM message.

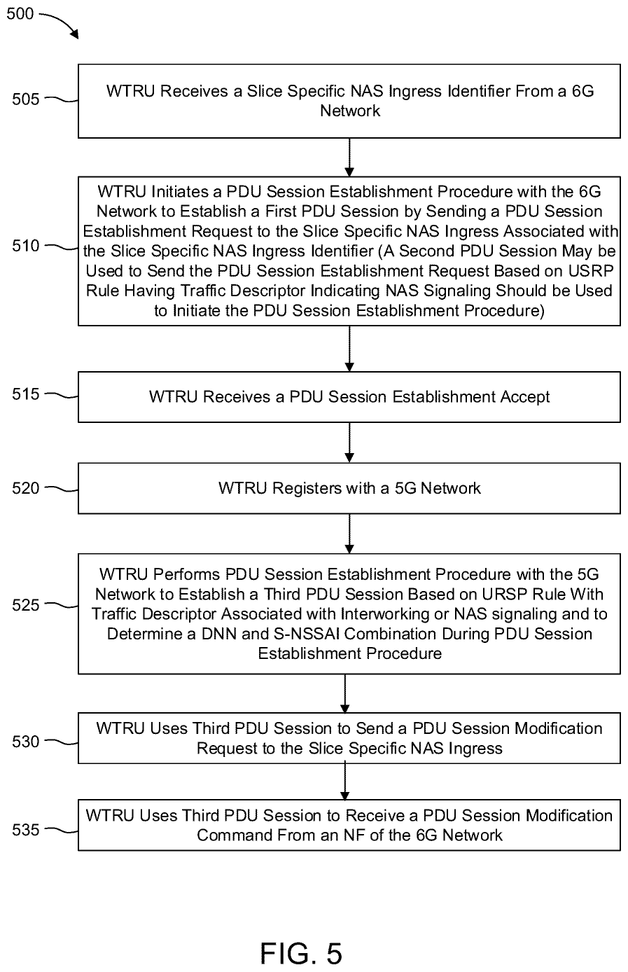

Referring to FIG. 5, a method 500 implemented in a WTRU for moving from a next generation network, e.g., 6G, to a legacy network, e.g., 5G is shown according to one example embodiment. At step 505, the WTRU receives a Slice Specific NAS Ingress Identifier from a 6G network. In step 510, the WTRU initiates a PDU session establishment procedure with the 6G network to a establish a first PDU session by sending a PDU Session Establishment Request to the Slice Specific NAS Ingress that is associated with the received Slice Specific NAS Ingress Identifier. In this regard, a second PDU session may be used to send the PDU Session Establishment Request message that initiates the PDU session establishment procedure. The WTRU may be configured with a URSP Rule that includes a traffic descriptor, and the traffic descriptor may indicate NAS signaling. The URSP Rule may be used by the WTRU to determine the which PDU session (e.g., the second PDU session) should be used to send the PDU Session Establishment Request message that initiates the PDU session establishment procedure to establish the first PDU session.

At step 515, the WTRU receives a PDU Session Establishment Accept message establishing the first PDU session. In step 520, the WTRU registers with a 5G network as described previously in regard to FIG. 2 steps 225 and 230. FIG. 5 method 500 continues at step 525 where the WTRU performs a PDU session establishment procedure with a 5G network to a establish a third PDU session (e.g., FIG. 2, steps 235 and 240). Prior to performing the PDU session establishment procedure, the WTRU may receive a URSP Rule. The URSP Rule may include a traffic descriptor. The traffic descriptor is associated with interworking or NAS signaling and the WTRU uses the URSP Rule to determine a DNN and S-NSSAI combination to indicate to the network during the PDU session establishment procedure.

At step 530, the WTRU may use the third PDU session to send a PDU Session Modification Request to the Slice Specific NAS Ingress. At step 535, the WTRU uses the third PDU session to receive a PDU Session Modification Command from an NF of the 6G network.

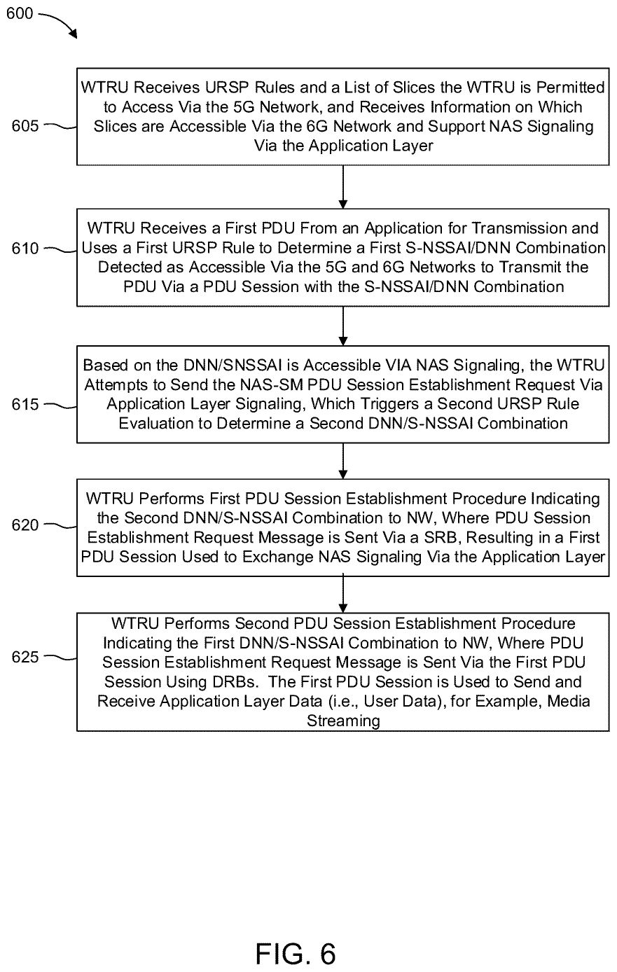

Referring to FIG. 6, a method 600 implemented in a WTRU for moving from a legacy network, e.g., 5G, to a next generation network, e.g., 6G is shown according to one example embodiment. In step 605, the WTRU receives URSP Rules and a list of slices that the WTRU is permitted to access via the 5G network. The WTRU also receives information indicating which slices are accessible via the 6G network and support NAS signaling via the application layer.

In step 610, the WTRU receives a first PDU from an application for transmission and uses a first URSP Rule evaluation procedure to determine a first S-NSSAI/DNN combination that should be used to transmit the PDU. The WTRU detects that the S-NSSAI/DNN combination is accessible via the 5G network and 6G network. The WTRU determines to establish a PDU session so that it can send data via the S-NSSAI/DNN combination. This may be performed similar to FIG. 3 steps 315 and 320 and FIG. 4 steps 405, 410 and 415.

FIG. 6 method 600 continues at step 615. Because the DNN/S-NSSAI is accessible via NAS signaling, the WTRU will attempt the send the NAS-SM PDU Session Establishment Request message via application layer signaling. Attempting to send the NAS-SM PDU Session Establishment Request message via application layer signaling will trigger a second URSP Rule evaluation procedure. The result of the second URSP Rule evaluation procedure is that a second DNN/S-NSSAI combination is determined. This may be equivalent to previously described FIG. 3 steps 315 and 320 and FIG. 4 steps 420 and 430.

In method 600 step 620, the WTRU will perform a first PDU session establishment procedure and indicate the second DNN/S-NSSAI combination to the network in the first PDU session establishment procedure. The PDU Session Establishment Request message will be sent to the network via an SRB. The result of this step is that a first PDU session will be established. The first PDU session is used to send and receive NAS signaling via the application layer. This may be equivalent to previously described FIG. 3 steps 315 and 320 and FIG. 4 step 435.

Lastly, in step 625, The WTRU will perform a second PDU session establishment procedure and indicate the first DNN/S-NSSAI combination to the network in the second PDU session establishment procedure. The PDU Session Establishment Request message will be sent to the network via an the first PDU session and via DRBs. The first PDU session is used to send and receive application layer data (i.e. User Data), for example, media streaming. This may be equivalent to previously described FIG. 3 steps 325 and FIG. 4 step 440.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for a wireless transmit/receive unit (WTRU) to transition from a first wireless network (NW1) to a second wireless network (NW2) having different session management protocols, the method comprising:
receiving, from the NW1, a slice specific non-access stratum (NAS) ingress identifier;
initiating a protocol data unit (PDU) session establishment procedure with the NW1 to establish a first PDU session based on a PDU session establishment request for communication with a slice specific NAS ingress function associated with the slice specific NAS ingress identifier;
receiving, from the NW1, a PDU session establishment accept message in response to the PDU session establishment request; and
registering with the NW2 and performing a PDU session establishment procedure with the NW2 to establish a third PDU session communicating control plane messages with the slice specific NAS ingress function associated with the slice specific NAS ingress identifier.

2. The method of claim 1, further comprising:
sending, via the third PDU session, a PDU session modification request to establish application layer contact with the slice specific NAS ingress function based on an IP address of the NAS ingress identifier.

3. The method of claim 1, wherein the slice specific NAS ingress identifier comprises an Internet Protocol (IP) address.

4. The method of claim 2, wherein a same IP address of the WTRU is used in the first PDU session and in the third PDU session.

5. The method of claim 1, wherein the PDU session establishment request is sent in a second PDU session with the NW1, wherein the second PDU session is a control plane established for communicating NAS messages with network slices.

6. The method of claim 1, wherein prior to establishing the third PDU session, the method further comprises:
receiving a route selection policy (RSP) rule having a traffic descriptor associated with interworking or NAS signaling, wherein the WTRU uses the RSP to determine a data network name (DNN) and a single network slice assistance information (S-NSSAI) combination to indicate to the NW2 during the PDU session establishment procedure with the NW2.

7. The method of claim 1, wherein the slice specific NAS ingress identifier is received in a registration response from the NW1.

8. The method of claim 5, wherein the slice specific NAS ingress identifier corresponds to a slice specific data network address identifier (DNAI) associated to a user plane function (UPF) where a network function corresponding to a network slice type the WTRU is allowed to access.

9. A wireless transmit/receive unit (WTRU) comprising:
a transceiver; and
a processor communicatively coupled with the transceiver and adapted to enable the WTRU to transition from a first wireless network (NW1) to a second wireless network (NW2) having different session management protocols by configuring the transceiver and the processor to:
receive, from the NW1, a slice specific non-access stratum (NAS) ingress identifier;
initiate a protocol data unit (PDU) session establishment procedure with the NW1 to establish a first PDU session based on a PDU session establishment request for communication with a slice specific NAS ingress function associated with the slice specific NAS ingress identifier;
receive, from the NW1, a PDU session establishment accept message in response to the PDU session establishment request; and
register with the NW2 and perform a PDU session establishment procedure with the NW2 to establish a third PDU session for exchanging control plane messages with the slice specific NAS ingress function associated with the slice specific NAS ingress identifier.

10. The WTRU of claim 9, wherein the transceiver and the processor are further configured to:
send, via the third PDU session, a PDU session modification request to establish application layer contact with the slice specific NAS ingress function based on an IP address of the NAS ingress identifier.

11. The WTRU of claim 9, wherein the slice specific NAS ingress identifier comprises an Internet Protocol (IP) address.

12. The WTRU of claim 10, wherein a same IP address of the WTRU is used in the first PDU session and in the third PDU session.

13. The WTRU of claim 9, wherein the PDU session establishment request is sent in a second PDU session with the NW1, wherein the second PDU session is a control plane established for communicating NAS messages with network slices.

14. The WTRU of claim 9, wherein prior to establishing the third PDU session, the transceiver and the processor are further configured to:
receive a route selection policy (RSP) rule having a traffic descriptor associated with interworking or NAS signaling, wherein the WTRU uses the RSP to determine a data network name (DNN) and a single network slice assistance information (S-NSSAI) combination to indicate to the NW2 during the PDU session establishment procedure with the NW2.

15. The WTRU of claim 9, wherein the slice specific NAS ingress identifier is received in a registration response from the NW1.

16. The WTRU of claim 13, wherein the slice specific NAS ingress identifier corresponds to a slice specific data network address identifier (DNAI) associated to a user plane function (UPF) where a network function corresponding to a network slice type the WTRU is allowed to access.

17. A method for a wireless transmit/receive unit (WTRU) to transition from a first wireless network (NW1) to a second wireless network (NW2) having different session management protocols, the method comprising:
receiving route selection policy (RSP) rules and a list of network slices the WTRU is permitted to access via the NW1 and information on which of the network slices are accessible via the NW2 and support non-access stratum (NAS) signaling via an application layer;
receiving a first protocol data unit (PDU) from an application for transmission and using a first RSP rule to determine a first single network slice selection assistance information (S-NSSAI) and data network name (DNN) combination detected as accessible via the NW1 and the NW2 to transmit the first PDU via a PDU session with the first S-NSSAI/DNN combination;
triggering a second RSP rule upon attempting to send a NAS session management PDU session establishment request to establish the PDU session, wherein the second RSP rule determines a second S-NSSAI/DNN combination;
performing a first PDU session establishment procedure indicating the second S-NSSAI/DNN combination, wherein a PDU session establishment request is sent via a signal radio bearer (SRB), resulting in a first PDU session used to exchange NAS signaling via the application layer; and
performing a second PDU session establishment procedure indicating the first S-NSSAI/DNN combination, wherein a PDU session establishment request message for the second PDU session establishment procedure is sent via the first PDU session using data radio bearers (DRBs) and used to communicate application layer data.

18. The method of claim 17, wherein the RSP rules and the list of network slices are received in a registration procedure with the NW1.

19. The method of claim 17, further comprising:
performing a registration procedure with the NW2;
maintaining the second PDU session; and
releasing the first PDU session.

20. The method of claim 19, further comprising:
performing a PDU session modification procedure to modify the second PDU session to stop signaling for the first PDU session.
